(19) United States
(12) Patent Application Publication
(10) Pub. No.: US 2013/0328985 A1
(43) Pub. Date: Dec. 12, 2013

(54) RECORDING APPARATUS

(71) Applicant: SEIKO EPSON CORPORATION, Tokyo (JP)

(72) Inventors: Kensuke Tamai, Shiojiri-shi (JP); Kazuhisa Takeda, Shiojiri-shi (JP); Tomoya Takikawa, Yokohama-shi (JP)

(21) Appl. No.: 13/915,209

(22) Filed: Jun. 11, 2013

(30) Foreign Application Priority Data
Jun. 12, 2012 (JP) 2012-132650

(51) Int. Cl. B41J 13/10

(52) U.S. Cl. CPC B41J 13/106
USPC 347/104

(57) ABSTRACT

A recording apparatus includes a transport unit that transports a recording medium, a recording unit, a discharge unit provided downstream from the recording unit, and a guide portion that is provided upstream from the discharge unit in a transport direction and that guides the recording medium to the discharge unit. The guide portion has a first guide section that guides the recording medium at a side end of the recording medium in a width direction that is orthogonal to the transport direction and a second guide section that guides the recording medium at a location closer to a central area of the recording medium than the first guide section.

The entire disclosure of Japanese Patent Application No: 2012-132650, filed Jun. 12, 2012 is expressly incorporated by reference herein in its entirety.

### BACKGROUND

1. Technical Field

The present invention relates to recording apparatuses.

2. Related Art

Recording apparatuses such as ink jet printers form printed images by ejecting ink from a recording head onto recording paper. However, there are situations where areas that are bent backward (that is, are curled) are formed in the recording paper when the paper is fed downstream from the recording head. For example, when a printed image is formed by ejecting ink from the recording head, the ink that lands on the recording paper moistens the recording paper. As a result, it is often the case that the end areas of the recording paper will curl upward more than the center area of the recording paper, even if the recording paper was not curled prior to the ink landing thereon. Furthermore, when moistened recording paper has dried, it is often the case that the end areas of the recording paper will curl upward more than the center area, in the same manner as mentioned above. Finally, there are also cases where there are already curls in the recording paper before printed images have been formed thereon.

Recording paper that is curled in this manner can easily cause the recording paper to jam (known as a “paper jam”); the technical content disclosed in JP-A-2009-126638 can be given as an example of a solution to paper jams caused by such curling. JP-A-2009-126638 discloses a recording apparatus including a curl correction mechanism that corrects curls in recording paper, where the curl correction mechanism has a pair of paper transport guides configured of an upper transport guide and a lower transport guide, and a gap varying mechanism that varies a gap between the pair of paper transport guides.

However, there are cases where paper guide members are disposed downstream from the recording head in the transport path of the recording paper, in order to prevent paper jams caused by curls in the recording paper. The paper guide member guides the transport of the recording paper from above that recording paper. The curled area of the recording paper making contact with such a paper guide member when the recording paper is transported can result in paper jams, and is thus not favorable.

Applying the configuration disclosed in JP-A-2009-126638 can be considered as a method for preventing such paper jams; however, while such a configuration may achieve an effect of correcting curls, the configuration is also made large and complex.

### SUMMARY

It is an advantage of some aspects of the invention to provide a recording apparatus capable of discharging recording paper while suppressing paper jams, even in the case where a curled area has been produced in the recording paper.

A recording apparatus according to an aspect of the invention includes a transport unit that transports a recording medium, a recording unit that records onto the recording medium transported by the transport unit, a discharge unit that is provided downstream from the recording unit in a transport direction of the recording medium and that discharges the recording medium, and a guide portion that is provided upstream from the discharge unit in the transport direction and that guides the recording medium to the discharge unit; the guide portion has a first guide section that guides the recording medium at a side end of the recording medium in a width direction that is orthogonal to the transport direction, and a second guide section that guides the recording medium at a location closer to a central area of the recording medium in the width direction than the first guide section; and the first guide section does not have an area that protrudes upstream more than the second guide section, and the first guide section is provided so that at least part of the first guide section is provided further downstream in the transport direction than the second guide section.

According to such a configuration, even if a large curled area is formed in a side end of the recording medium in the width direction thereof, that large curled area is guided by the first guide section after the central area of the recording medium in the width direction thereof is guided by the second guide section. Through this, even if there is an area in the center of the recording medium that is slightly curled, that curled area is pressed down by the second guide section, and the large curled area at the side end is then pressed down as a result of the central area being pressed down by the second guide section. Accordingly, even if the large curled area is present in the side end of the recording medium, the recording medium can be transported downstream while the guide portion prevents paper jams from occurring.

According to another aspect of the invention, it is preferable, in the above invention, for the guide portion to further include a support portion that supports the recording medium; and for a guide member to be provided in a position that can face the support portion, sloped portions to be provided in the first guide section and the second guide section, and the sloped portions to be provided so as to become closer to the support portion as the sloped portions progress downstream in the transport direction.

According to this configuration, the central area of the recording medium in the width direction thereof is first guided toward the support portion by the sloped portion at the second guide section. Meanwhile, a portion of the recording medium toward a side end thereof in the width direction is guided toward the support portion by the sloped portion at the first guide section after the central area of the recording medium in the width direction thereof. Accordingly, even if the large curled area is present in the side end of the recording medium, the recording medium can be transported downstream while the guide portion prevents paper jams from occurring.

Furthermore, according to another aspect of the invention, it is preferable, in the above invention, for the first guide section to be provided on both side ends of the guide portion in the width direction.

According to this configuration, even if a large curled area is present in both side ends of the recording medium in the width direction thereof, the recording medium can be transported downstream while preventing paper jams caused by curled areas at both of the side ends.

Furthermore, according to another aspect of the invention, it is preferable, in the above invention, for the first guide sections to be provided so as to gradually progress toward the downstream side as the first guide sections progress from the center in the width direction toward the side ends.

According to this configuration, as the recording medium is transported downstream, the recording medium is gradually guided by the first guide section from the area of the curled area that is closer toward the center in the width direction thereof toward the area of the curled area that is closer to the side end. Accordingly, the recording medium can be transported downstream while preventing, in a favorable manner, paper jams in the curled area.

Furthermore, according to another aspect of the invention, it is preferable, in the above invention, for the second guide section to be provided so as to gradually progress toward the downstream side as the second guide section progresses from the center in the width direction toward the side ends.

According to this configuration, it is possible to guide the recording medium using the second guide section in the same manner as the first guide section as the recording medium is transported downstream, even in the case where the curled area is present in a narrow recording medium, the case where the curled area is present in the central area of the recording medium in the width direction thereof, and so on. Furthermore, the recording medium can be transported downstream while preventing, in a favorable manner, paper jams in the curled area, particularly in the case where the center of the recording medium in the width direction thereof serves as a reference for positioning the recording medium (that is, in the case of what is known as a “center feed” type).

Furthermore, according to another aspect of the invention, it is preferable, in the above invention, for the first guide section to be provided in a stepped shape so as to progress in steps toward the downstream side as the first guide section progresses from the center in the width direction toward the side ends.

According to this configuration, as the recording medium is transported downstream, the recording medium is guided by the first guide section in steps from the area of the curled area that is closer toward the center in the width direction thereof toward the area of the curled area that is closer to the side end. Accordingly, the recording medium can be transported downstream while preventing, in a favorable manner, paper jams in the curled area.

Furthermore, according to another aspect of the invention, it is preferable, in the above invention, for the first guide section to be provided on both side ends of the guide portion in the width direction, and to be further provided in at least one area between the two side ends.

According to this configuration, the first guide section is provided in at least one area between both side ends of the guide portion, and thus it is possible to transport the recording medium downstream while preventing, in a favorable manner, paper jams in the curled area, particularly in the case where one side end of the recording medium serves as a reference for positioning the recording medium (that is, in the case of the so-called “off-center” type).

Furthermore, according to another aspect of the invention, it is preferable, in the above invention, for an end of the sloped portion at the first guide section that is distanced from the support portion to be provided further from the support portion than an end of the sloped portion at the second guide section that is distanced from the support portion.

According to this configuration, the length of the sloped portion in the direction moving away from the support portion is greater at the first guide section than at the second guide section. Accordingly, even if a large curled area is present in the side end of the recording medium in the width direction thereof, the recording medium can be transported downstream while the sloped portion at the first guide section prevents paper jams from occurring.

### BRIEF DESCRIPTION OF THE DRAWINGS

The invention will be described with reference to the accompanying drawings, wherein like numbers reference like elements.

FIG. 1 is a cross-sectional view, taken from the side, illustrating the interior of a recording apparatus.

FIG. 2 is a perspective view illustrating the shape of a paper guide member according to a first embodiment.

FIG. 3 is a cross-sectional view, taken from the side, illustrating the configuration of the paper guide member according to the first embodiment.

FIG. 4 is a perspective view illustrating the paper guide member viewed from the bottom thereof.

FIG. 5 is a perspective view illustrating the occurrence of a curled area in recording paper.

FIG. 6 is a perspective view illustrating a past paper guide member viewed from the bottom thereof.

FIG. 7 is a cross-sectional view, taken from the side, illustrating a curled area colliding with an end of the past paper guide member.

FIG. 8 is a plan view illustrating an image of a curled area being eliminated by a receding guide section.

FIG. 9 is a plan view illustrating the shape of a paper guide member according to another embodiment.

FIG. 10 is a plan view illustrating the shape of a paper guide member according to another embodiment.

FIGS. 11A and 11B are diagrams illustrating a paper guide member according to another embodiment, where FIG. 11A is a plan view and FIG. 11B is a front view.

FIGS. 12A and 12B are diagrams illustrating a paper guide member according to another embodiment, where FIG. 12A is a plan view and FIG. 12B is a front view.

FIG. 13 is a plan view illustrating the shape of a paper guide member according to another embodiment.

### DESCRIPTION OF EXEMPLARY EMBODIMENTS

### First Embodiment

Hereinafter, a recording apparatus 10 according to a first embodiment of the invention will be described with reference to the drawings.

### Configuration of Recording Apparatus 10

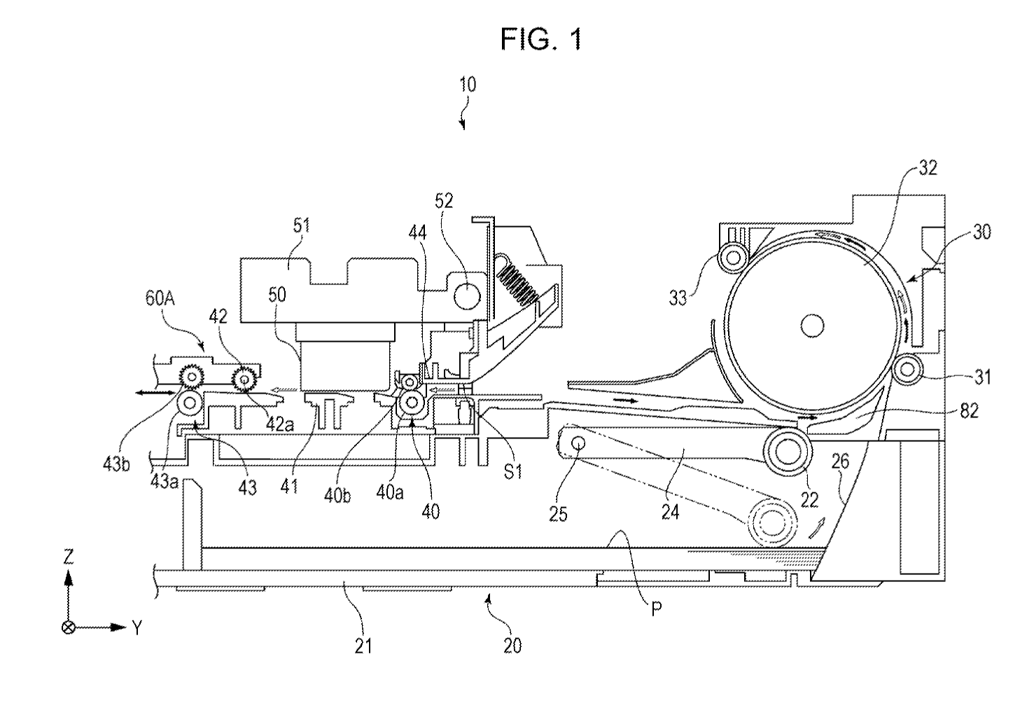

FIG. 1 is a cross-sectional view, taken from the side, illustrating a path in the recording apparatus 10 according to the invention through which recording paper P is transported. Note that although the recording paper P corresponds to an example of recording medium, a recording target aside from the recording paper P, such as a film-form member or the like, may be used as the recording medium. Furthermore, “recording” as referred to in this specification includes printing.

There are cases where an XYZ orthogonal coordinate system such as that shown in FIG. 1 is referred to in the following descriptions; in this coordinate system, a width direction of the recording apparatus 10 is taken as the X direction, a direction moving away from an installation surface on which the recording apparatus 10 is installed (that is, a vertical direction) is taken as the Z direction, and a direction orthogonal to both the X direction and the Z direction is taken as the Y direction. Note that the X direction corresponds to a main scanning direction in which a carriage moves, and the Y direction corresponds to a sub scanning direction in which the recording paper is transported. Furthermore, a side to which recording paper that has been printed upon is discharged is taken as a downstream side or a discharge side, and the side opposite thereto is taken as an upstream side or a paper feed side.

Although the recording apparatus 10 is, for example, an ink jet printer, the invention may also be applied in an apparatus aside from an ink jet printer. Furthermore, as long as the apparatus is capable of recording by ejecting ink, the ink jet printer may be an apparatus that employs any type of ejecting method. For example, instead of a technique in which a carriage makes scans, a so-called “line head” technique, in which a recording unit spans the width direction of the recording medium, may be employed as well.

The recording apparatus 10 includes a front-loading paper feed mechanism 20, and the recording paper P from the front-loading paper feed mechanism 20 is transported toward a recording head 50 (corresponding to a “recording unit”) and discharged downstream after being recorded upon by the recording head 50. The front-loading paper feed mechanism 20 includes a paper cassette 21 and a pick-up roller 22. The paper cassette 21 is capable of holding a plurality of sheets of the recording paper P therein, in a stacked state. The pick-up roller 22 makes contact with the recording paper P held in the paper cassette 21 and is rotationally driven by a motor (not shown), and as a result, the recording paper P located on the top of the stack is fed out from the paper cassette 21 toward a separating member 26, which will be mentioned later. The pick-up roller 22 is attached to an arm member 24. The arm member 24 is provided so as to be capable of pivoting central to a pivot shaft 25.

In the recording apparatus 10, the separating member 26 is provided above and toward the rear surface relative to the paper cassette 21. The separating member 26 makes the recording paper P advance upward and toward the rear surface so as to make contact with a leading end of the uppermost recording paper P that is fed out by the pick-up roller 22. As a result of this contact, the uppermost sheet of the recording paper P is separated from the remaining sheets of the recording paper P located therebelow.

The recording paper P fed by the front-loading paper feed mechanism 20 is sent to a guide roller unit 30. The guide roller unit 30 includes a separating roller 31, an intermediate roller 32, and an assist roller 33. The separating roller 31 and the intermediate roller 32 have a function for separating the uppermost sheet of the recording paper P from the remaining plurality of sheets of the recording paper P. In other words, in the case where a plurality of sheets of the recording paper P have entered into the area between the separating roller 31 and the intermediate roller 32, the uppermost sheet of the recording paper P is separated from the remaining sheets of the recording paper P by using the rotational resistance of the separating roller 31, which has been set to be greater than the friction between the sheets of the recording paper P.

The assist roller 33 is provided downstream from the separating roller 31 in the transport direction. The assist roller 33 undergoes slave rotation under the force of the intermediate roller 32, and guides the recording paper P downstream in the transport direction by pinching the recording paper P against the intermediate roller 32.

A transport roller pair 40, a platen 41, guide rollers 42, and a discharge roller pair 43 are provided downstream from the guide roller unit 30 in the transport direction of the recording paper P. The transport roller pair 40 (this corresponds to a “transport unit”) includes a transport driving roller 40a and a transport slave roller 40b. The transport driving roller 40a is driven by a transport motor, which is not shown in the drawings; the transport slave roller 40b is pressed against the transport driving roller 40a while being axially supported by a transport support member 44, and the transport slave roller 40b undergoes slave rotation under the pressure from the transport driving roller 40a. Through such a configuration, the recording paper P is transported toward the recording head 50.

Meanwhile, a sheet end detection sensor S1 is provided in the transport support member 44 that axially supports the transport slave roller 40b, on the end side of the downstream side. The sheet end detection sensor S1 makes it possible to detect the positions of the leading end and following end of the recording paper P.

The platen 41 is provided downstream from the transport roller pair 40 in the transport direction of the recording paper P, and the platen 41 corresponds to a support portion that supports the transported recording paper P from below. The recording head 50 is provided above the platen 41 so as to be capable of facing the platen 41. The recording head 50 is attached to a lower area of a carriage 51. The carriage 51 is guided by a carriage shaft 52 that extends in the width direction of the recording apparatus 10 (the main scanning direction; the X direction), and is moved back and forth in the main scanning direction under the driving of a carriage motor, which is not shown in the drawings. Cartridges (not shown) that hold inks of mutually different colors, such as yellow (Y), magenta (M), cyan (C), and black (K), are mounted in the carriage 51; ink is supplied to the recording head 50 from these cartridges, and the ink can then be ejected from the recording head 50.

The guide roller 42, which is also called a knurled roller, is provided downstream from the recording head 50 in the transport direction of the recording paper P. A plurality of the guide rollers 42 are present, and the plurality of guide rollers 42 are disposed along the main scanning direction; the respective guide rollers 42 are attached to a paper guide member 60A via a shared rotation shaft 42a. However, a configuration in which the guide rollers 42 are attached to the paper guide member 60A via individual rotation shafts may also be employed.

The discharge roller pair 43 (corresponding to a “discharge unit”) is provided downstream from the guide rollers 42 in the transport direction of the recording paper P. The discharge roller pair 43 includes a discharge driving roller 43a and a discharge slave roller 43b. The discharge driving roller 43a is driven by a discharge motor, which is not shown in the drawings, whereas the discharge slave roller 43b is axially supported by the paper guide member 60A in a freely-rotatable state. The discharge slave roller 43b is pressurized by the discharge driving roller 43a, and the discharge slave roller 43b undergoes slave rotation under the pressure of the discharge driving roller 43a. Through such a configuration, the recording paper P is sent downstream (toward the discharge side).

### Paper Guide Member 60A

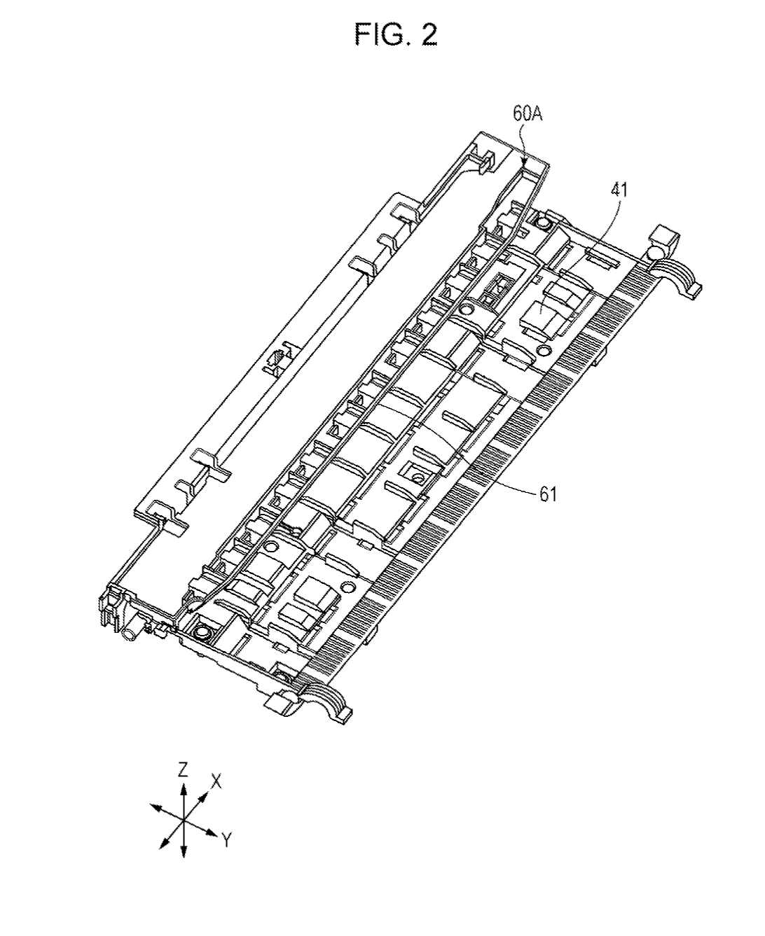

Next, the paper guide member 60A will be described. FIG. 2 is a perspective view illustrating the shape of the paper guide member 60A. As shown in FIG. 1 and FIG. 2, the paper guide member 60A is a member that is positioned above the platen 41 and that has a long shape that takes the main scanning direction as its longer dimension. The paper guide member 60A is a member that guides the recording paper P, sent from the upstream side, from above.

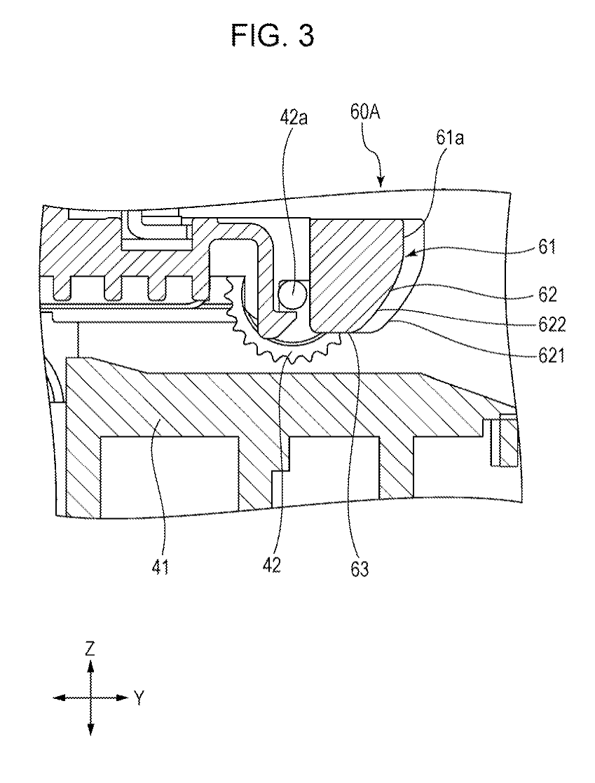

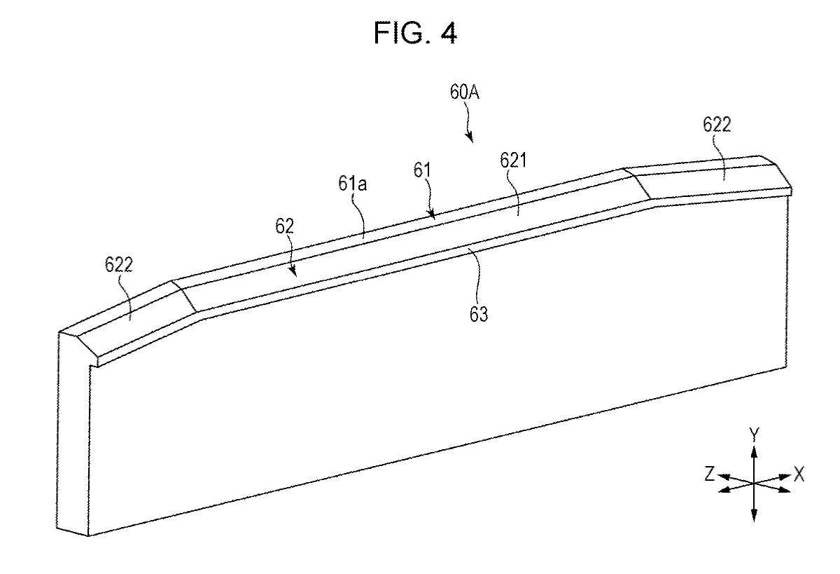

FIG. 3 is a cross-sectional view of the paper guide member 60A, seen from the side. FIG. 4 is a perspective view illustrating the paper guide member 60A viewed from below (the bottom thereof). Note that FIG. 4 illustrates the vicinity of a sloped guide portion 62 that is characteristic to the paper guide member 60A, and omits depictions of various types of shapes, such as protrusions and recesses, that are also present in the paper guide member 60A.

As shown in FIG. 3 and FIG. 4, the sloped guide portion 62, corresponding to a “sloped portion”, is provided upstream from the paper guide member 60A. Although the sloped guide portion 62 is provided on an upstream end surface 61 of the paper guide member 60A, in the configuration illustrated in FIG. 3 and FIG. 4, the sloped guide portion 62 is not provided across the entirety of the stated end surface 61, and is instead provided spanning downward from an area partway along the height direction of the end surface 61.

The sloped guide portion 62 is a sloped area that conducts the recording paper P advancing downstream into the area between the paper guide member 60A and the platen 41. The sloped guide portion 62 is provided as a tapered shape that gradually becomes closer to the platen 41 (that is, becomes lower) as the portion progresses toward the downstream side to which the recording paper P is transported.

Here, as shown in FIG. 3, a bottom surface 63 of the paper guide member 60A, which continues from the sloped guide portion 62, is positioned higher than the position of the lowest part of the guide rollers 42. Accordingly, the recording paper P that is sent downstream while making contact with the sloped guide portion 62 makes contact with the guide rollers 42 and progresses further downstream while the guide rollers 42 undergo slave rotation under the pressure from the recording paper P.

Note that the paper guide member 60A may serve as an element that corresponds to a “guide portion”, but the sloped guide portion 62 of the paper guide member may instead serve as the element that corresponds to the guide portion (the same applies to paper guide members 60B to 60E, which will be described later).

The sloped guide portion 62 will be described in further detail hereinafter. As shown in FIG. 2 and FIG. 4, the sloped guide portion 62 is provided so that a central area thereof, aside from both side ends thereof, is parallel to the main scanning direction, whereas both side ends are not provided parallel to the main scanning direction. Both side ends of the sloped guide portion 62 are provided having sloped shapes that gradually progress toward (recede toward) the downstream side as the sloped guide portion 62 progresses from the central area to both side ends.

In the following descriptions, the central area of the sloped guide portion 62, excluding both side ends thereof, will be referred to as a parallel guide section 621, whereas the areas corresponding to both side ends of the sloped guide portion 62 will be referred to as a receding guide section 622. The parallel guide section 621 corresponds to a “second guide section”, whereas the receding guide section 622 corresponds to a “first guide section”.

Note that the parallel guide section 621 and the receding guide section 622 are both provided as shapes that gradually become closer to the platen 41 (that is, become lower) as the sections progress toward the downstream side in which the recording paper P is transported.

### Effects of Paper Guide Member 60A

According to the configuration described above, when the recording paper P that has passed through the area where the recording head 50 and the platen 41 face each other advances downstream, the leading end of the recording paper P will approach the end surface 61 of the paper guide member 60A.

However, there are cases where areas that are bent backward (that is, are curled) are formed in the leading end of the recording paper P. In particular, in the case where a printed image has been formed on the recording paper P by ejecting ink from the recording head 50, there are cases where the recording paper P is moistened by the ink landing thereon and a curled area P1 is produced in the recording paper P due to the moistening, the recording paper P drying after being moistened, and so on.

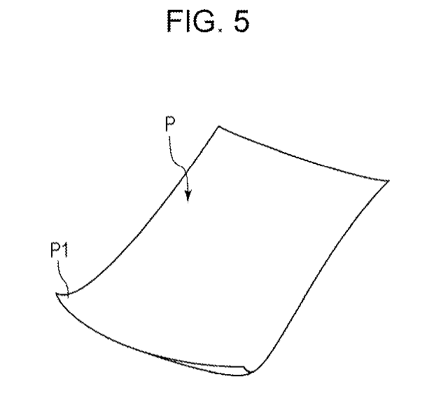

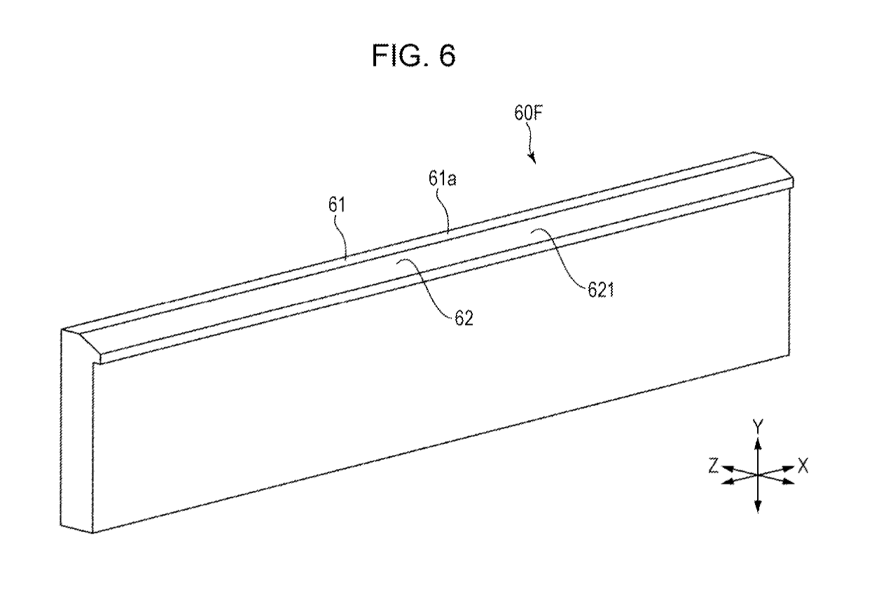

As shown in FIG. 5, there are some curled areas P1 where a side end of the recording paper P in the main scanning direction lifts upward more than the central area of the recording paper P in the main scanning direction. Such a curled area P1 being produced has, with a past paper guide member 60F such as that shown in FIG. 6, resulted in the recording paper P jamming (known as a “paper jam”).

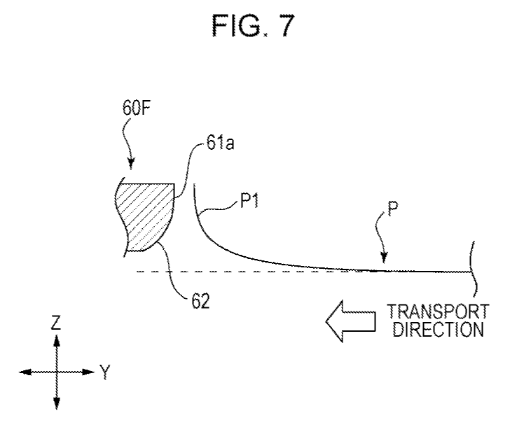

This will be described based on FIG. 7. FIG. 7 is a cross-sectional view illustrating, from the side, an image of the curled area P1 of the recording paper P colliding with a side end of the past paper guide member 60F in the case where that paper guide member 60F is used. As shown in FIG. 7, when the curled area P1 is formed, there is a section of the curled area P1 that is positioned higher than the sloped guide portion 62. Accordingly, there is a portion of the curled area P1 that collides with the end surface 61 on the upper side of the sloped guide portion 62 (that is, an upper end surface 61a). In the case where the recording paper P is sent downstream in the transport direction after the stated collision, the portion of the curled area P1 that collides with the upper end surface 61a will not be guided toward the platen 41 (that is, guided downward), and as a result, the portion of the curled area P1 that collided with the upper end surface 61a will deform, being bent, folded, or the like; an area in which the recording paper P as a whole is bent, folded, or the like will also be formed. In other words, the curled area P1 being formed in the recording paper P can easily become a cause of paper jams.

However, in this embodiment, the receding guide sections 622 are provided in both side ends of the paper guide member 60A, as shown in FIG. 3 and FIG. 4. Accordingly, it is possible to suppress the occurrence of paper jams even if the curled area P1 is formed in the recording paper P.

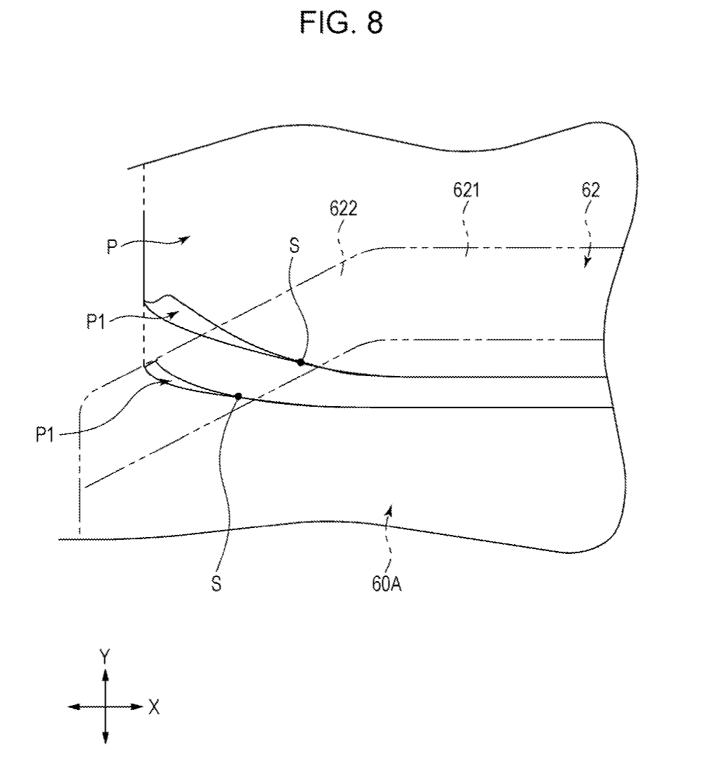

The prevention of paper jams by the receding guide section 622 is illustrated in FIG. 8. FIG. 8 is a plan view illustrating an image of the curled area P1 being eliminated by the receding guide section 622 when the recording paper P is transported; in FIG. 8, the paper guide member 60A is depicted as being transparent. Note that in FIG. 8, the curled area P1 causes a side end of the recording paper P in the width direction thereof (that is, the X direction) to lift upward, and the central area of the recording paper P in the width direction thereof (the X direction) is located relatively lower than the curled area P1.

As is clear from FIG. 8, the parallel guide section 621 is located upstream in the transport direction from the receding guide section 622. Accordingly, the central area of the recording paper P reaches the sloped guide portion 62 earlier than the curled area P1, or passes below the sloped guide portion 62. As a result, first, as the central area of the recording paper P advances downstream in the transport direction, that central area is guided so as to move downward (that is, toward the platen 41). To rephrase, because the distance between the parallel guide section 621 and the recording head 50 is shorter than the distance between the receding guide section 622 and the recording head 50, the central area of the recording paper P that passes the recording head 50 makes contact with the paper guide member 60A or passes therebelow before the side ends of the recording paper P.

Incidentally, when the central area of the recording paper P is positioned lower, an area of the curled area P1 that is closer to the central area of the recording paper P is relatively lower than an area of the curled area P1 that is closer to the side end of the recording paper P. However, the positional relationship between the respective areas of the receding guide sections 622 is as follows. That is, areas of the receding guide sections 622 that are closer to the parallel guide section 621 (that is, closer to the center) are positioned further upstream in the transport direction than areas of the receding guide sections 622 that are closer to the side ends. Accordingly, when the recording paper P advances downstream, an area of the curled area P1 that is closer to the center and lower first collides with the sloped guide portion 62 at the parallel guide section 621 or with the sloped guide portion 62 at the receding guide section 622. Note that in FIG. 8, the area where the recording paper P collides is indicated as a colliding area S, and the colliding area S is depicted as making contact with the receding guide section 622.

At this time, the colliding area S of the curled area P1 collides with the sloped guide portion 62 with certainty, unlike the area of the curled area P1 that is closer to the side end (in other words, a higher area); a lower area of the curled area P1, which is closer to the center, is pushed downward (guided) by the sloped guide portion 62 as the recording paper P advances downstream in the transport direction.

Due to the area of the curled area P1 that is closer to the center being pushed down, the area of the curled area P1 that is closer to the side end is also pushed down. In other words, as the recording paper P advances downstream in the transport direction, the area of the curled area P1 that is closer to the center is first pushed downward by the sloped guide portion 62. After this, the area of the curled area P1 that is closer to the side is also pushed down as a result of the area of the curled area P1 closer to the center being pushed down. Accordingly, as the recording paper P advances, the recording paper P is gradually guided by the sloped guide portion 62 from the central area of the curled area P1 toward the side end area of the curled area P1, and the areas of the curled area P1 that have not yet reached the receding guide section 622 are also gradually pushed down.

In this manner, the entire curled area P1 is guided downward by the receding guide section 622 in a favorable manner. After being sent downstream by the slave rotation of the guide rollers 42, the recording paper P reaches the discharge roller pair 43 and is then sent further downstream (toward the discharge side).

### Effects

According to the recording apparatus 10 configured as described above, even if a large curled area P1 is formed in a side end of the recording paper P in the width direction thereof (that is, the X direction), that large curled area P1 is guided by the receding guide section 622 after the central area of the recording paper P in the width direction thereof (the X direction) is guided by the parallel guide section 621. Through this, even if there is an area in the center of the recording paper P that is slightly curled, that curled area is pressed down by the parallel guide section 621, and the large curled area P1 at the side end is then pressed down by the receding guide section 622 as a result of the central area being pressed down by the parallel guide section 621. Accordingly, even if the large curled area P1 is present in the side end of the recording paper P, the recording paper P can be transported downstream while the paper guide member 60A prevents paper jams from occurring.

Furthermore, in this embodiment, the paper guide member 60A is provided with the sloped guide portion 62, and both the parallel guide section 621 and the receding guide section 622 are present in the sloped guide portion 62. Accordingly, the central area of the recording paper P in the width direction thereof (the X direction) is first guided toward the platen 41 by the sloped guide portion 62 at the parallel guide section 621, after which the side ends of the recording paper P in the width direction thereof (the X direction) are guided by the sloped guide portion 62 at the receding guide sections 622. Accordingly, even if a large curled area P1 is present in the side ends of the recording paper P, the recording paper P can be transported downstream in the transport direction while the paper guide member 60A prevents paper jams from occurring.

Further still, in this embodiment, the receding guide sections 622 are provided in both side ends of the paper guide member 60A in the lengthwise direction thereof (that is, the X direction). Accordingly, even if a large curled area P1 is present in both side ends of the recording paper P in the width direction thereof (the X direction), the recording paper P can be transported downstream in the transport direction while preventing paper jams caused by curled areas P1 at both of the side ends.

In addition, in this embodiment, the receding guide sections 622 are provided so as to gradually progress toward the downstream side as the receding guide sections progress from the center in the lengthwise direction (the X direction) toward the side ends. Accordingly, as the recording paper P is transported downstream in the transport direction, the recording paper P is gradually guided by the receding guide section 622 from the area of the curled area P1 that is closer toward the center in the width direction thereof (the X direction) toward the area of the curled area P1 that is closer to the side end. Accordingly, the recording paper P can be transported downstream while suppressing, in a favorable manner, paper jams in the curled area P1.

### Second Embodiment

Hereinafter, a recording apparatus 10 according to a second embodiment of the invention will be described with reference to the drawings. In this embodiment, elements that are the same as in the recording apparatus 10 according to the above first embodiment will be described using the same names and reference numerals.

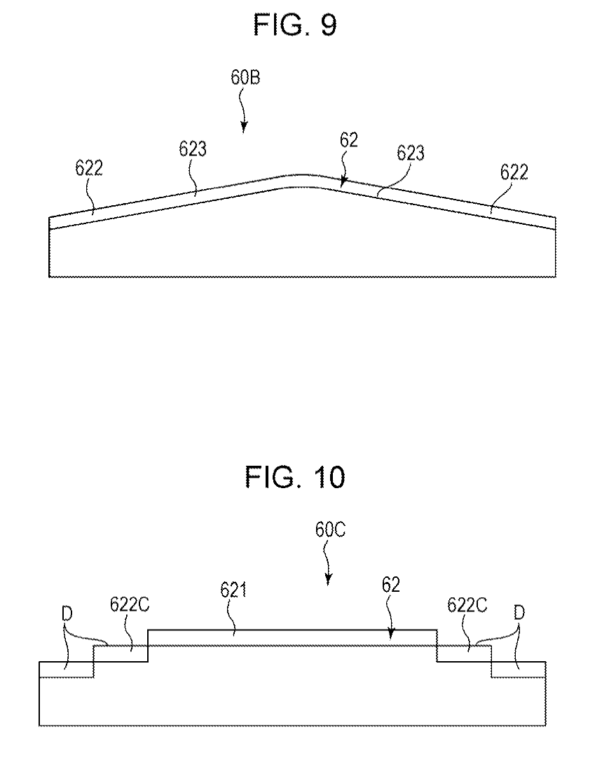

In this embodiment, a paper guide member 60B that is different from the paper guide member 60A of the first embodiment is used. The configuration of the paper guide member 60B is illustrated in FIG. 9. FIG. 9 is a plan view illustrating the shape of the paper guide member 60B, seen from the bottom thereof.

The paper guide member 60B according to this embodiment does not include the parallel guide section 621. That is, the paper guide member 60B corresponds to a configuration in which a receding guide section 623 having a similar slope to the receding guide section 622 is provided instead of the parallel guide section 621 in the aforementioned first embodiment (the receding guide section 623 corresponds to the second guide section). However, extending the receding guide section 622 toward the central area in the lengthwise direction (the X direction) and using that configuration as a new receding guide section is a concept that may be employed as well.

Note that the sloped guide portion 62 at the receding guide sections 622 and 623 is the same as the sloped guide portion 62 in the aforementioned first embodiment.

Using the paper guide member 60B configured in this manner is particularly useful in the case where the center of the recording paper P in the width direction thereof (the X direction) serves as a reference for positioning the recording paper P (that is, in the case of what is known as a “center feed” type). That is, the recording paper P can have a variety of widths. Even if the curled area P1 is produced in recording paper P having a variety of widths, an area of the curled area P1 that is toward the center and relatively lower first collides with an area of the receding guide section 622 or 623 and is guided downward when the recording paper P is transported downstream. As the recording paper P is transported further, the area of the curled area P1 that is guided downward gradually widens toward the side end of the curled area P1, and ultimately the entire curled area P1 is guided downward.

In this manner, using the paper guide member 60B according to this embodiment makes it possible to guide the recording paper P using the receding guide section 622 or 623 as the recording paper P is transported downstream in the transport direction, even in the case where the curled area P1 has occurred in a narrow recording paper P, the case where the curled area P1 has occurred in the central area of the recording paper P in the width direction thereof (the X direction), and so on. Furthermore, the recording paper P can be transported downstream while preventing, in a favorable manner, paper jams in the curled area P1, particularly in the case of what is known as a “center feed” type.

### Third Embodiment

Hereinafter, a recording apparatus 10 according to a third embodiment of the invention will be described with reference to the drawings. In this embodiment, elements that are the same as in the recording apparatus 10 according to the above first embodiment will be described using the same names and reference numerals.

In this embodiment, a paper guide member 60C that is different from the paper guide members 60A and 60B of the first and second embodiments is used. The configuration of the paper guide member 60C is illustrated in FIG. 10. FIG. 10 is a plan view illustrating the shape of the paper guide member 60C, seen from the bottom thereof.

As shown in FIG. 10, the paper guide member 60C is configured having the same parallel guide section 621 as in the aforementioned first embodiment. However, the paper guide member 60C is provided with a receding guide section 622C that is different from the receding guide section 622 in the aforementioned first embodiment.

That is, the receding guide section 622 in the first embodiment is provided having a sloped shape that gradually progresses toward the downstream side in the transport direction (that is, recedes) as the receding guide section 622 progresses from the central area in the lengthwise direction thereof (the X direction) toward the side ends in the lengthwise direction thereof (the X direction). However, the receding guide section 622C according to this embodiment is provided having a stepped shape that progresses toward the downstream side (that is, recedes) in steps, as the receding guide section 622C progresses from the central area in the lengthwise direction thereof (the X direction) toward the side ends in the lengthwise direction thereof (the X direction).

In other words, a plurality of step sections D are provided in the receding guide section 622C in different positions in the transport direction, and the step sections D are provided so that the step sections D at the side ends in the lengthwise direction (the X direction) are positioned further downstream in the transport direction. Note that in the configuration shown in FIG. 10, the step sections D are provided at both side ends in the lengthwise direction (the X direction), and two step sections D are provided in the respective side ends in the lengthwise direction (the X direction). However, any number of step sections D may be provided.

Even in the case where this type of paper guide member 60C is used, as the recording paper P is transported downstream in the transport direction, the recording paper P is guided in steps by the receding guide section 622C from the area of the curled area P1 that is closer toward the center in the width direction thereof (the X direction) toward the area of the curled area P1 that is closer to the side end. Accordingly, the recording paper P can be transported downstream while preventing, in a favorable manner, paper jams in the curled area P1.

### Fourth Embodiment

Hereinafter, a recording apparatus 10 according to a fourth embodiment of the invention will be described with reference to the drawings. In this embodiment, elements that are the same as in the recording apparatus 10 according to the above first embodiment will be described using the same names and reference numerals.

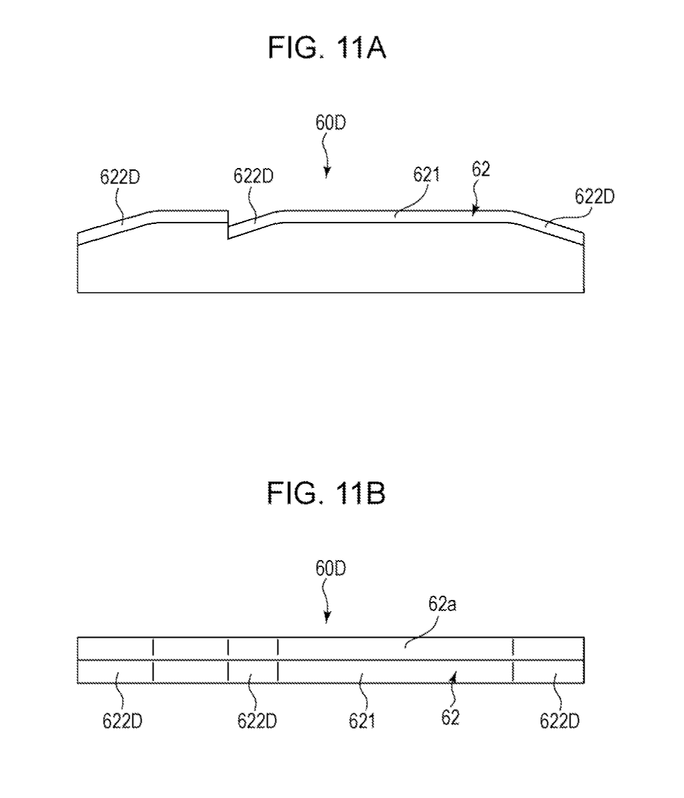

In this embodiment, a paper guide member 60D that is different from the paper guide members 60A, 60B, and 60C of the first to third embodiments is used. The configuration of the paper guide member 60D is illustrated in FIGS. 11A and 11B. FIG. 11A is a plan view illustrating the shape of the paper guide member 60D, seen from the bottom thereof and FIG. 11B is a diagram viewing the paper guide member 60D from the front thereof.

As shown in FIGS. 11A and 11B, the paper guide member 60D is configured having the same parallel guide section 621 as in the aforementioned first embodiment. However, the paper guide member 60D is provided with a receding guide section 622D that is different from the receding guide section 622 in the aforementioned first embodiment.

Specifically, the receding guide section 622D is provided on both side ends, namely one side end and another side end, in the width direction of the paper guide member 60D. In addition, the receding guide section 622D is also provided in an area of the paper guide member 60D that is partway between the one side end and the other side end in the width direction thereof. Note that the number of receding guide sections 622D provided partway along the width direction may be one, or may be two or more.

Incidentally, the paper guide member 60D illustrated in FIGS. 11A and 11B corresponds to a case in which one of the side ends of the recording paper P serves as a reference for positioning the recording paper P (what is known as an “off-center” type). For example, in FIGS. 11A and 11B, in the case where the right side of the paper guide member 60D (that is, the one side end) serves as a reference for positioning the recording paper P, the position of the left side of the recording paper P (that is, the other side end) relative to the paper guide member 60D will vary depending on the width of the recording paper P. For example, with comparatively narrow recording paper P such as L-size paper, postcard-size paper, or the like, and comparatively wide recording paper P such as A4-size paper, the positions of the left side end (that is, the other side end) of those types of recording paper P relative to the paper guide member 60D are completely different.

Accordingly, in order for the paper guide member 60D shown in FIGS. 11A and 11B to handle an off-center type, the same receding guide section 622D as that positioned on the left side end in FIGS. 11A and 11B is also provided in a position toward the right side end by a predetermined distance from the left side end.

Using such a paper guide member 60D makes it possible to transport the recording paper P downstream in the transport direction while preventing, in a favorable manner, paper jams in the curled area P1, particularly in the case where one side end of the recording paper P serves as a reference for positioning the recording paper P (that is, in the case of the so-called “off-center” type).

### Fifth Embodiment

Hereinafter, a recording apparatus 10 according to a fifth embodiment of the invention will be described with reference to the drawings. In this embodiment, elements that are the same as in the recording apparatus 10 according to the above first embodiment will be described using the same names and reference numerals.

In this embodiment, paper guide members 60E1 and 60E2 that are different from the paper guide members 60A, 60B, 60C, and 60D of the first to fourth embodiments are used. However, the characteristic configurations of the paper guide members 60E1 and 60E2 can be applied in the paper guide members 60A, 60B, 60C, and 60D.

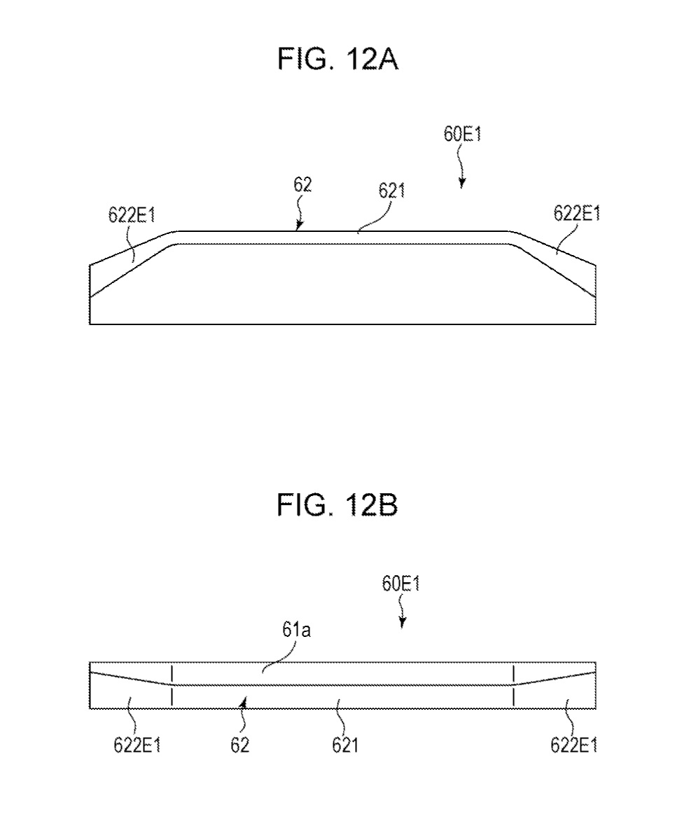

The configuration of the paper guide member 60E1 is illustrated in FIGS. 12A and 12B. FIGS. 12A and 12B are diagrams illustrating the configuration of the paper guide member 60E1, where FIG. 12A is a plan view illustrating the configuration of the paper guide member 60E1 in the vicinity of the parallel guide section 621, and FIG. 12B is a front view illustrating the configuration of the paper guide member 60E1 in the vicinity of a receding guide section 622E1.

As shown in FIGS. 12A and 12B, in the paper guide member 60E1, the sloped guide portion 62 differs between the parallel guide section 621 and the receding guide section 622E1. Specifically, in the receding guide section 622E1, an upper starting point of the sloped guide portion 62 is provided in a position that moves further upward (that is, away from the platen 41) than an upper starting point of the sloped guide portion 62 at the parallel guide section 621, as the paper guide member 60E1 progresses toward the ends in the lengthwise direction thereof (the X direction).

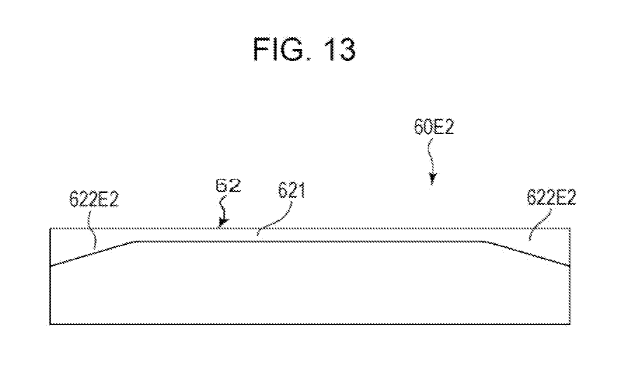

Note that in addition to a configuration such as that shown in FIGS. 12A and 12B, a paper guide member 60E2 configured as shown in FIG. 13 may be employed. FIG. 13 is a plan view of the paper guide member 60E2. As shown in FIG. 13, the paper guide member 60E2 is provided so that, when viewed from above, the shape of the paper guide member 60E2 is essentially rectangular, and the length of the sloped portion of the sloped guide portion 62 at a receding guide section 622E2 becomes greater toward the side ends in the lengthwise direction of the paper guide member 60E2 (the X direction). Through this, in the receding guide section 622E2, an upper starting point of the sloped guide portion 62 is provided in a position that moves further upward (that is, away from the platen 41) as the paper guide member 60E2 progresses toward the ends in the lengthwise direction thereof (the X direction).

In the case where such paper guide members 60E1 and 60E2 are used, the vertical dimensions of the sloped guide portion 62 at the receding guide sections 622E1 and 622E2 are greater at the side ends in the lengthwise direction thereof (the X direction) than those at the central area sides in the lengthwise direction thereof. Accordingly, even if a large curled area P1 is produced at a side end of the recording paper P in the width direction thereof (the X direction), the sloped guide portion 62 at the receding guide sections 622E1 and 622E2 can further prevent the occurrence of paper jams, and the recording paper P can be transported downstream in the transport direction while preventing such paper jams from occurring.

### Variations

The foregoing describes first to fifth embodiments of the invention, but it should be noted that many variations on the invention can be made. Such variations will be described hereinafter.

### 1. Variation 1

In the aforementioned embodiments, a protruding portion that protrudes upstream may be provided in the parallel guide section 621 of the paper guide members 60A to 60E (60E1 and 60E2), and the protruding portion may be configured to protrude toward the central area of the recording paper P first. In the case where such a configuration is employed, the recording paper P is first guided by the protruding portion. Note that this protruding portion can also be included in the concept of the first guide section.

### 2. Variation 2

The aforementioned embodiments describe the paper guide members 60A to 60E, which have a shape that is longer in the width direction. However, paper guide members having comparatively short lengths in the width direction may be aligned in the width direction and used.

### 3. Variation 3

The aforementioned embodiments describe a configuration in which the receding guide section 622 is provided at both side ends in the width direction. However, a configuration in which the receding guide section is provided only at one side end in the width direction may also be employed. Even if such a configuration is used, paper jams caused by the curled area P1 being formed can be prevented at the one side end of the recording paper P.

### 4. Variation 4

In addition to the aforementioned ink jet printers, laser printers can also be included in the concept of the recording apparatus 10 in the aforementioned embodiments. That is, the invention can also be applied in laser printers. The concept of the recording apparatus 10 can also include fluid ejecting apparatuses that eject liquids aside from ink (including liquids themselves, a liquid matter in which particles of a functional material are dispersed or mixed throughout a liquid, matters having fluid properties such as gels, and so on), and the invention can also be applied in such fluid ejecting apparatuses. A liquid ejecting apparatus that ejects liquids including materials such as electrode materials, coloring materials (pixel materials), and so on in a dispersed or dissolved state for use in the manufacture and so on of liquid-crystal displays, EL (electroluminescence) displays, and surface light emission displays; a fluid ejecting apparatus that ejects bioorganic matters used in the manufacture of biochips; a fluid ejecting apparatus that ejects liquids to be used as samples and is used as a precision pipette; and so on are examples of such fluid ejecting apparatuses.

### 5. Variation 5

Furthermore, the concept of the recording apparatus 10 according to the invention may also include fluid ejecting apparatuses that perform pinpoint ejection of lubrication oils into the precision mechanisms of clocks, cameras, and the like; fluid ejecting apparatuses that eject transparent resin liquids such as ultraviolet curing resins onto a substrate in order to form miniature hemispheric lenses (optical lenses) for use in optical communication elements and the like; fluid ejecting apparatus that eject an etching liquid such as an acid or alkali onto a substrate or the like for etching; and fluid ejecting apparatuses that eject fluid such as gels (for example, physical gels).

The entire disclosure of Japanese Patent Application No.: 2012-132650, filed Jun. 12, 2012 is expressly incorporated by reference herein.

What is claimed is:

1. A recording apparatus comprising:
a transport unit that transports a recording medium;
a recording unit that records onto the recording medium transported by the transport unit;
a discharge unit that is provided downstream from the recording unit in a transport direction of the recording medium and that discharges the recording medium; and
a guide portion that is provided upstream from the discharge unit in the transport direction and that guides the recording medium to the discharge unit,
wherein the guide portion includes:
a first guide section that guides the recording medium at a side end of the recording medium in a width direction that is orthogonal to the transport direction; and
a second guide section that guides the recording medium at a location closer to a central area of the recording medium in the width direction than the first guide section, and
wherein the first guide section does not have an area that protrudes upstream more than the second guide section, and the first guide section is provided so that at least part of the first guide section is provided further downstream in the transport direction than the second guide section.

2. The recording apparatus according to claim 1, further comprising:
a support portion that supports the recording medium,
wherein the guide portion is provided in a position capable of facing the support portion;
sloped portions are provided in the first guide section and the second guide section; and
the sloped portions are provided so as to become closer to the support portion as the sloped portions progress downstream in the transport direction.

3. The recording apparatus according to claim 1,
wherein the first guide section is provided on both side ends of the guide portion in the width direction.

4. The recording apparatus according to claim 3,
wherein the first guide sections are provided so as to gradually progress toward the downstream side as the first guide sections progress from the center in the width direction toward the side ends.

5. The recording apparatus according to claim 4,
wherein the second guide section is provided so as to gradually progress toward the downstream side as the second guide section progresses from the center in the width direction toward the side ends.

6. The recording apparatus according to claim 1,
wherein the first guide section is provided in a stepped shape so as to progress in steps toward the downstream side as the first guide section progresses from the center in the width direction toward the side ends.

7. The recording apparatus according to claim 1,
wherein the first guide section is provided on both side ends of the guide portion in the width direction, and is further provided in at least one area between the two side ends.

8. The recording apparatus according to claim 2,
wherein the first guide section is provided so that an area of the first guide section that faces the support portion is further from the support portion than the second guide section.

9. A recording apparatus comprising:
a transport unit that transports a recording medium;
a recording unit including a recording head that records onto the recording medium transported by the transport unit;
a discharge unit that is provided downstream from the recording unit in a transport direction of the recording medium and that discharges the recording medium; and
a guide portion that is provided upstream from the discharge unit in the transport direction and that guides the recording medium to the discharge unit,
wherein the guide portion includes:
a first guide section that guides the recording medium at a side end of the recording medium in a width direction that is orthogonal to the transport direction; and
a second guide section that guides the recording medium at a location closer to a central area of the recording medium in the width direction than the first guide section, and
a distance between the second guide section and the recording head is shorter than a distance between the first guide section and the recording head.
